(19) United States
(12) Patent Application Publication
(10) Pub. No.: US 2025/0246656 A1
(43) Pub. Date: Jul. 31, 2025

(54) FUEL CELL SYSTEM

(71) Applicant: TOYOTA JIDOSHA KABUSHIKI KAISHA, Toyota-shi (JP)

(72) Inventors: Makito OKUMURA, Nagoya-shi (JP); Ryouichi NAMBA, Okazaki-shi (JP)

(73) Assignee: TOYOTA JIDOSHA KABUSHIKI KAISHA, Toyota-shi (JP)

(21) Appl. No.: 18/925,555

(22) Filed: Oct. 24, 2024

(30) Foreign Application Priority Data
Jan. 29, 2024 (JP) 2024-010709

(51) Int. Cl. H01M 8/04791; H01M 8/04111; H01M 8/0438; H01M 8/04537; H01M 8/04746; H01M 8/04858; H01M 8/10

(52) U.S. Cl. CPC H01M 8/04798; H01M 8/04111; H01M 8/04395; H01M 8/04544; H01M 8/04574; H01M 8/04604; H01M 8/04776; H01M 8/04865; H01M 2008/1095

(57) ABSTRACT

A fuel cell system, comprising a fuel cell, an air compressor, a flow rate sensor, a current sensor, a voltage sensor, and a load device and a control unit, so that the required flow rate, the control unit controls the air compressor, a first air stoichiometric ratio a pull-up operation for supplying the cathode gas so that the lower second air stoichiometric ratio than the first air stoichiometric ratio, and performing either a pull-down operation to supply the cathode gas so that the lower second air stoichiometric ratio, in the case where the pull-down operation is being performed, when the first condition is satisfied, the pull-up operation is performed for a first time, when the second condition is satisfied, not perform the pull-up operation.

### CROSS-REFERENCE TO RELATED APPLICATION

This application claims priority to Japanese Patent Application No. 2024-010709 filed on Jan. 29, 2024, incorporated herein by reference in its entirety.

BACKGROUND

### 1. Technical Field

The present disclosure relates to a fuel cell system.

### 2. Description of Related Art

In order to suppress deterioration of a fuel cell, it is necessary to suppress drying of a stack. In a fuel cell system according to Japanese Unexamined Patent Application Publication No. 2020-4675 (JP 2020-4675 A), drying of a stack is suppressed by adjusting the amount of generated water generated by power generation per unit time. More specifically, in the fuel cell system according to JP 2020-4675 A, the amount of a cathode gas supplied to the stack is reduced to reduce the amount of water removed by the cathode gas. This suppresses drying of the stack.

In such a case, the stoichiometric air ratio is lower than normal. The stoichiometric air ratio is the ratio of the amount of cathode gas actually supplied to the stack to the minimum amount of cathode gas required to generate power required for a load. The stoichiometric air ratio indicates that a smaller amount of cathode gas is supplied to the stack as the ratio is lower.

In the fuel cell system according to JP 2020-4675 A, the stoichiometric air ratio is kept at 1.0 or more. The fuel cell system adjusts the flow rate of the cathode gas in a state where an anode gas is supplied in an amount required to generate the required power. That is, when the air stoichiometric ratio fluctuates, the power generated by the fuel cell also fluctuates. When the generated power is more or less than the required power, a secondary battery included in the fuel cell system discharges the insufficient power or charges the surplus power.

When the stoichiometric air ratio is lower than normal, water tends to accumulate in the stack. When surplus water is generated in the stack, flooding occurs. Since flooding causes a concentration overvoltage, the fuel cell may not be able to output the required power due to a decrease in the output voltage. Therefore, the fuel cell system according to JP 2020-4675 A performs a drainage process before flooding occurs. The drainage process increases the amount of cathode gas supplied to the stack, and therefore water accumulated in the stack is removed.

The output voltage of a fuel cell decreases due to the occurrence of an overvoltage composed of an activation overvoltage, a resistance overvoltage, and a concentration overvoltage. The overvoltage increases as the output current increases. Further, as the output current increases, the ratio of the concentration overvoltage in the overvoltage increases remarkably. That is, the amount of change in the output voltage with respect to the output current tends to increase as the ratio of the concentration overvoltage in the overvoltage increases. The fuel cell system adjusts the output power by adjusting the output current of the fuel cell using a direct current-direct current (DCDC) converter. When the ratio of the concentration overvoltage in the overvoltage changes, however, it is difficult to adjust the output power with a constant accuracy.

### SUMMARY

The drainage process of the fuel cell system according to JP 2020-4675 A facilitates drying of the stack, and thus may accelerate deterioration of the fuel cell. Therefore, the inventors have studied a method of reducing the drainage process in a state where the stoichiometric air ratio is lower than normal.

When the drainage process is reduced, however, a concentration overvoltage due to flooding tends to occur. The fuel cell system increases the generated power by increasing the flow rate of the cathode gas. That is, when the current required by the load is constant, the output voltage increases. Therefore, when the output voltage drops due to the concentration overvoltage, the fuel cell system recovers the dropped output voltage by increasing the flow rate of the cathode gas. However, water in the stack is removed by increasing the flow rate of the cathode gas. Thus, the concentration overvoltage due to flooding is resolved. This increases the output voltage of the fuel cell, and therefore the fuel cell system returns the flow rate of the cathode gas to the value before the concentration overvoltage due to flooding occurs. Since the drainage process is reduced in a state where the stoichiometric air ratio is lower than normal, however, flooding occurs and disappears again.

That is, the operating point defined by the output voltage and the output current of the fuel cell fluctuates between a region in which the ratio of the concentration overvoltage in the overvoltage is relatively large and a region in which the ratio of the concentration overvoltage is relatively small.

As the operating point fluctuates, the amount of variation in the output voltage with respect to the output current of the fuel cell varies. This makes it difficult to adjust the output power with a constant accuracy as described above. Thus, there has been a demand for a technique of suppressing drying of the stack and reducing fluctuations in the operating point.

The present disclosure can be implemented in the following aspects.
(1) An aspect of the present disclosure provides a fuel cell system. The fuel cell system includes:
   a fuel cell;
   an air compressor that adjusts a flow rate of a cathode gas that flows into the fuel cell;
   a flow rate sensor that acquires the flow rate;
   a current sensor that acquires an output current of the fuel cell;
   a voltage sensor that acquires an output voltage of the fuel cell;
   a load device that consumes output power of the fuel cell; and
   a control unit that controls the fuel cell system, in which the control unit is configured to:
   control the air compressor such that the flow rate is brought to a predetermined required flow rate for outputting the output voltage corresponding to a required current determined based on required power required from the load device and the output power;
   execute one of pull-up operation for supplying the cathode gas to the air compressor so as to achieve a first stoichiometric air ratio that is a stoichiometric air ratio of 1 or more, and pull-down operation for supplying the cathode gas to the air compressor so as to achieve a second stoichiometric air ratio that is a stoichiometric air ratio of 1 or more and less than the first stoichiometric air ratio; and
   when the pull-down operation is being executed, execute the pull-up operation for a predetermined first period of time when a first condition is met, the first condition including the output voltage or the output current having a value included in a first range, and
   not execute the pull-up operation when a second condition is met, the second condition including the output voltage or the output current having a value included in a second range that is lower than the first range.

With such a configuration, the fuel cell system according to the present disclosure performs the pull-up operation for the first period of time when the output current or the output voltage has a value included in the first range. In the pull-up operation, the stoichiometric air ratio is higher than that in the pull-down operation, and therefore the amount of water removed from the fuel cell is larger than that in the pull-down operation. That is, the concentration overvoltage due to flooding is less likely to occur in the pull-up operation than in the pull-down operation. Thus, the fuel cell system according to the present disclosure can suppress fluctuations in the operating point. Further, in the fuel cell system according to the present disclosure, the cathode gas is increased according to the concentration overvoltage due to flooding, and therefore deterioration due to drying of the fuel cell can be suppressed as compared with a configuration in which the flow rate of the cathode gas is increased so as not to cause flooding.
(2) Another aspect of the present disclosure provides a fuel cell system. The fuel cell system includes:
   a fuel cell;
   an air compressor that adjusts a flow rate of a cathode gas that flows into the fuel cell;
   a flow rate sensor that acquires the flow rate;
   a current sensor that acquires an output current of the fuel cell;
   a voltage sensor that acquires an output voltage of the fuel cell;
   a load device that consumes output power of the fuel cell;
   an output adjustment unit that adjusts the output current to a required current determined based on required power required from the load device and the output power; and
   a control unit that controls the fuel cell system, in which the control unit is configured to: control the air compressor such that the flow rate is brought to a predetermined required flow rate for outputting the output voltage corresponding to the required current;
   execute one of pull-up operation for supplying the cathode gas to the air compressor so as to achieve a first stoichiometric air ratio that is a stoichiometric air ratio of 1 or more, and pull-down operation for supplying the cathode gas to the air compressor so as to achieve a second stoichiometric air ratio that is a stoichiometric air ratio of 1 or more and less than the first stoichiometric air ratio; and
   when the pull-down operation is being executed and the required current is controlled such that a response speed of the output current is brought to a first response speed, execute first control for controlling the response speed of the output current to a second response speed that is lower than the first response speed when a first condition is met, the first condition including the output voltage or the output current having a value included in a first range, and
   not execute the first control when a second condition is met, the second condition including the output voltage or the output current having a value included in a second range that is lower than the first range.

With such a configuration, the fuel cell system according to the present disclosure controls the required current such that the response speed of the output current is brought to a second response speed that is lower than the first response speed when the output current or the output voltage has a value included in the first range. The air compressor is controlled so as to provide a required flow rate for outputting an output voltage corresponding to the required current. That is, when the required current gently fluctuates, the flow rate of the cathode gas also gently fluctuates. Consequently, fluctuations in the amount of water contained in the fuel cell are suppressed, and thus the ratio of the concentration overvoltage in the overvoltage does not easily fluctuate. Thus, the fuel cell system according to the present disclosure suppresses fluctuations in the operating point in the pull-down operation by suppressing fluctuations in the concentration overvoltage due to flooding. Further, in the fuel cell system according to the present disclosure, the cathode gas is increased according to the concentration overvoltage due to flooding, and therefore deterioration due to drying of the fuel cell can be suppressed as compared with a configuration in which the flow rate of the cathode gas is increased so as not to cause flooding.
(3) In the fuel cell system according to the above aspect, the first condition may include an amplitude of the output voltage or the output current in a predetermined period being included in the first range.

With such a configuration, the fuel cell system according to the present disclosure can suppress the control to be performed when the first condition is met being erroneously executed due to an instantaneous fluctuation in the output voltage or the output current that is shorter than the predetermined period.
(4) In the fuel cell system according to the above aspect, the control unit may execute the pull-down operation after a lapse of the first period of time.

With such a configuration, the fuel cell system according to the present disclosure can suppress drying of the fuel cell better than in a configuration in which the pull-down operation is not performed after the lapse of the first period of time.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is an explanatory view showing a configuration of a fuel cell system according to a first embodiment;

FIG. 2 is an explanatory view showing an operating point of a fuel cell stack;

FIG. 3 is an explanatory view showing an operating point of a fuel cell stack;

FIG. 4 is a flowchart illustrating a control method of the fuel cell system according to the first embodiment;

FIG. 5 is a flow chart showing a control process of the fuel cell system according to the second embodiment; and

FIG. 6 is a waveform showing the output power of the second embodiment.

### DETAILED DESCRIPTION OF EMBODIMENTS

### A. First Embodiment

### A-1. Configuration of Fuel Cell System

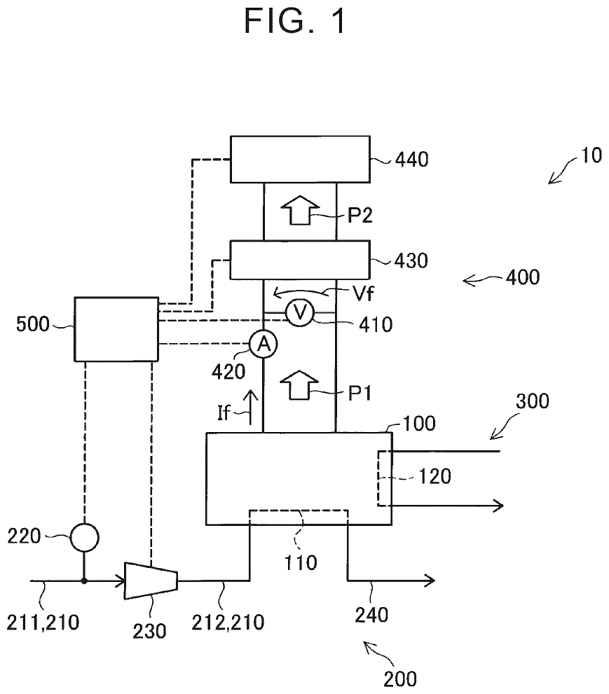

FIG. 1 is an explanatory diagram illustrating a configuration of a fuel cell system 10 according to a first embodiment. The fuel cell system 10 includes a fuel cell stack 100, a cathode gas supply/discharge system 200, an anode gas supply/discharge system 300, an output circuit 400, and a control unit 500. The fuel cell system 10 of the present embodiment is mounted on a battery electric vehicle, for example, and is used as a power source for driving or various devices.

The fuel cell stack 100 generates electric power by receiving the supply of the anode gas and the cathode gas as the reaction gas. For example, the anode gas is hydrogen and the cathode gas is air. The fuel cell stack 100 is a polymer electrolyte fuel cell, and has a stack structure in which a plurality of unit cells serving as a power generator are stacked. As used herein, a “fuel cell stack” is also simply referred to as a “fuel cell” or a “stack.”

The single cell includes Membrane Electrode Assembly (MEA), a pair of gas diffusion layers arranged to sandwich MEA, and a pair of gas separators arranged on the outer side of each gas diffusion layer. MEA includes an electrolyte membrane, and an anode and a cathode, which are catalytic electrode layers formed on respective surfaces of the electrolyte membrane. In each single cell, an anode gas flow path 120 through which the anode gas flows is formed on the anode side and a cathode gas flow path 110 through which the cathode gas flows is formed on the cathode side with the electrolyte membrane interposed therebetween. In FIG. 1, a single cell is omitted to facilitate understanding of the technology.

In the cathode, generated water is generated as the electrochemical reaction proceeds. This increases the amount of water contained in the cathode gas flow path 110. However, since moisture in the cathode gas flow path 110 is removed by the cathode gas, the amount of moisture contained in the cathode gas flow path 110 varies depending on the amount of generated water and the flow rate of the cathode gas. Therefore, depending on the flow rate of the cathode gas, drying of the cathode gas flow path 110 and flooding are likely to occur in the cathode gas flow path 110. The adjustment of the water content of the cathode gas flow path 110 by the fuel cell system 10 will be described in detail later. In this specification, the water content of the fuel cell stack 100 means the water content of the cathode gas flow path 110.

The cathode gas supply/discharge system 200 supplies the cathode gas to the fuel cell stack 100 and discharges the cathode gas from the fuel cell stack 100. The cathode gas supply/discharge system 200 includes a cathode gas supply pipe 210, a flow rate sensor 220, an air compressor 230, and a cathode gas discharge pipe 240.

The cathode gas supply pipe 210 supplies the cathode gas outside the fuel cell system 10 to the fuel cell stack 100. The cathode gas supply pipe 210 includes a first cathode gas supply pipe 211 that connects the outside and the inlet of the air compressor 230, and a second cathode gas supply pipe 212 that connects the outlet of the air compressor 230 and the inlet of the cathode gas flow path 110. Accordingly, the cathode gas supply pipe 210 supplies the cathode gas supplied from the outside by the air compressor 230 to the cathode gas flow path 110.

The flow rate sensor 220 acquires a flow rate of the cathode gas. More specifically, the flow rate sensor 220 measures the flow rate of the cathode gas flowing from the first cathode gas supply pipe 211 toward the air compressor 230. The flow rate sensor 220 sends the acquired flow rate to the control unit 500.

The air compressor 230 regulates the flow rate of the cathode gas flowing into the fuel cell stack 100. More specifically, the air compressor 230 compresses the cathode gas from the first cathode gas supply pipe 211 and discharges the cathode gas to the second cathode gas supply pipe 212. The air compressor 230 adjusts the flow rate of the cathode gas by compressing the cathode gas in accordance with an instruction from the control unit 500.

The output voltage Vf of the fuel cell stack 100 is adjusted by adjusting the flow rate of the cathode gas. The control of the electric power of the fuel cell system 10 will be described in detail later. Further, by adjusting the flow rate of the cathode gas, the water content of the fuel cell stack 100 is adjusted as described above.

The cathode gas discharge pipe 240 discharges the cathode gas discharged from the fuel cell stack 100 to the outside of the fuel cell system 10.

The anode gas supply/discharge system 300 supplies the anode gas to the fuel cell stack 100 and discharges the anode gas from the fuel cell stack 100. The anode gas supply/discharge system 300 includes an anode gas tank, an anode gas pump, and the like. Further, the anode gas supply/discharge system 300 includes a supply pipe, an exhaust pipe, and the like that allow the anode gas supplied from the anode gas tank to flow through the anode gas flow path 120. However, in order to facilitate understanding of the technology, the configuration of the anode gas supply/discharge system 300 is not shown in FIG. 1.

In this specification, the fuel cell system 10 operates in a state in which the anode gas is supplied to the anode gas supply/discharge system 300 in an amount necessary for generating the required electric power.

The output circuit 400 supplies power from the fuel cell stack 100 according to the required power of the load device 440. The output circuit 400 includes a voltage sensor 410, a current sensor 420, an output adjustment unit 430, and a load device 440.

The voltage sensor 410 obtains an output voltage Vf of the fuel cell stack 100. The voltage sensor 410 sends the obtained output voltage Vf to the control unit 500.

The current sensor 420 obtains an output current If of the fuel cell stack 100. The current sensor 420 sends the obtained output current If to the control unit 500.

The output adjustment unit 430 adjusts the output power P1 of the fuel cell stack 100 in accordance with the required power of the load. More specifically, the output adjustment unit 430 adjusts the output current If so that the required current is determined based on the required power and the output power P1 of the load device 440. The control of the output adjustment unit 430 will be described in detail later. The output adjustment unit 430 is specifically a DCDC converter. The output adjustment unit 430 is connected to an output of electric power of the fuel cell stack 100.

Further, the output adjustment unit 430 transforms the output voltage Vf of the fuel cell stack 100 into a voltage required by the load device 440. For example, the driving device of the motor included in the load device 130 requires a higher voltage than the output voltage Vf of the fuel cell stack 100. For this reason, the output adjustment unit 430 boosts the output voltage Vf of the fuel cell stack 100 to a voltage required by the drive device of the motor. The “output adjustment unit” is also referred to as “FDC”.

The load device 440 consumes the power P1. More specifically, the load device 130 consumes the output power P1 adjusted by the output adjustment unit 430 in accordance with the required power. In the present specification, the load power P2 is the output power P1 adjusted by the output adjustment unit 430. Further, the load power P2 required for the load device 130 is referred to as “required power”. The load device 440 includes, for example, a drive device for a vehicle including a motor and a drive circuit for a motor, an air compressor 230, an anode gas pump, and the like. The load device 440 sends the required load power P2 to the control unit 500.

The control unit 500 controls the fuel cell system 10. The control unit 500 is configured as a logic circuit mainly including a microcomputer. More specifically, the control unit 500 includes a CPU, a ROM, a RAM, and input/output ports for inputting and outputting various types of signals. CPU executes a preset control program. ROM stores in advance control programs, control data, and the like required for executing various arithmetic processes in CPU. RAM temporarily reads and writes various types of data required for performing various types of arithmetic operations in CPU. The function of the control unit 500 will be described below.

### A-2. Pull-Up and Pull-Down Operations

The control unit 500 controls the flow rate of the cathode gas by the air compressor 230 to perform either an air stoichiometric raising operation or an air stoichiometric lowering operation. The air stoichiometry ratio is a ratio of the amount of the cathode gas actually supplied to the fuel cell stack 100 to the minimum amount of the cathode gas required to generate the required electric power. That is, the air stoichiometry ratio is 1.0 or more.

The operation of raising the air stoichiometric ratio is an operation of supplying the cathode gas to the air compressor 230 so that the air stoichiometric ratio becomes the first air stoichiometric ratio. Specifically, the first air stoichiometry ratio is 1.5. The first air stoichiometry ratio is based on an air stoichiometry ratio at which the power consumption of the drive device of the vehicle is maximized. That is, the first air stoichiometry ratio is based on an air stoichiometry ratio that maximizes the electric power obtained by excluding the electric power consumed by the air compressor 230, the cathode pump, and the like from the output power P1 of the fuel cell stack 100.

The operation of lowering the air stoichiometric ratio is an operation of supplying the cathode gas to the air compressor 230 so that the air stoichiometric ratio becomes a second air stoichiometric ratio lower than the first. For example, when the first air stoichiometry ratio is 1.5, the second air stoichiometry ratio is a value included in a range of 1.2 or more and 1.3 or less.

The reduced operation of the air stoichiometry reduces the flow rate of the cathode gas compared to the case of the first air stoichiometry. The decrease in the flow rate of the cathode gas reduces the amount of water removed from the fuel cell stack 100. That is, since the amount of water contained in the fuel cell stack 100 increases, drying of the fuel cell stack 100 is suppressed. However, flooding is likely to occur due to an increase in the water content of the fuel cell stack 100. Incidentally, the “raising operation of the air stoichiometric ratio” is also simply referred to as “raising operation”, and the “lowering operation of the air stoichiometric ratio” is also simply referred to as “lowering operation”.

Even in the case of the pulling-up operation of the air stoichiometry, the cathode gas supplied from the air compressor 230 is dried, and thus the fuel cell stack 100 may be partially dried. In particular, the inlet portion of the cathode gas flow path 110 may dry. In such a case, the fuel cell stack 100 is suppressed from being dried by performing the operation of lowering the air stoichiometric ratio.

### A-3. Equal Power Operation

The control unit 500 further executes an equal power operation such as controlling an output power Pl of the fuel cell stack 100 in accordance with the required power of the load device 440. More specifically, the control unit 500 acquires information on the required power by the load device 130. The control unit 500 controls the air compressor 230 based on a predetermined reference value of the output voltage Vf in accordance with the required power. When the cathode gas is supplied to the fuel cell stack 100, the fuel cell stack 100 starts power generation, and thus an output voltage Vf is generated. Further, the control unit 500 controls the output adjustment unit 430 based on a predetermined reference value of the output current If in accordance with the required power. That is, the output adjustment unit 430 extracts the output current If from the fuel cell stack 100 based on the reference value of the output current If to output an output current If corresponding to the reference value of the output current If. In addition, the control unit 500 acquires the output current If and the output voltage Vf by the voltage sensor 410 and the current sensor 420. The control unit 500 calculates the output power P1 based on the acquired output current If and the output voltage Vf. The control unit 500 calculates the required current to be extracted by the output adjustment unit 430 based on the difference between the output power P1 and the required power and the reference value of the output current If. That is, the required current varies according to the difference between the output power P1 and the required power. The control unit 500 sets the required current to a command value for controlling the output adjustment unit 430. Thus, the output adjustment unit 430 adjusts the output current If so as to be a required current determined based on the required power of the load device 440 and the output power. That is, the output adjustment unit 430 causes the fuel cell stack 100 to output the output power P1 satisfying the required power. The operation of the fuel cell system 10 is referred to as “equal power operation”.

As described above, the air stoichiometry ratio is a ratio of the amount of the cathode gas actually supplied to the fuel cell stack 100 to the minimum amount of the cathode gas required to generate the required electric power. During the raising operation or the lowering operation of the air stoichiometric ratio, it is necessary to vary the flow rate of the cathode gas according to the required power. Therefore, the control unit 500 controls the air compressor 230 so that the flow rate of the cathode gas becomes the required flow rate. The required flow rate is a predetermined flow rate for causing an output voltage Vf corresponding to the required current to be output.

For example, in a case where an equal-power operation is performed while the air stoichiometric ratio is being lowered, the control unit 500 causes the air compressor 230 to increase the flow rate of the cathode gas in accordance with an increase in the required current. Increasing the required current occurs according to the difference between the output power P1 and the required power as described above. For example, an increase in the required current occurs when the required power increases or when the output power P1 decreases in response to a decrease in the output voltage Vf due to a density overvoltage caused by flooding.

### A-4. Variation of Operating Point

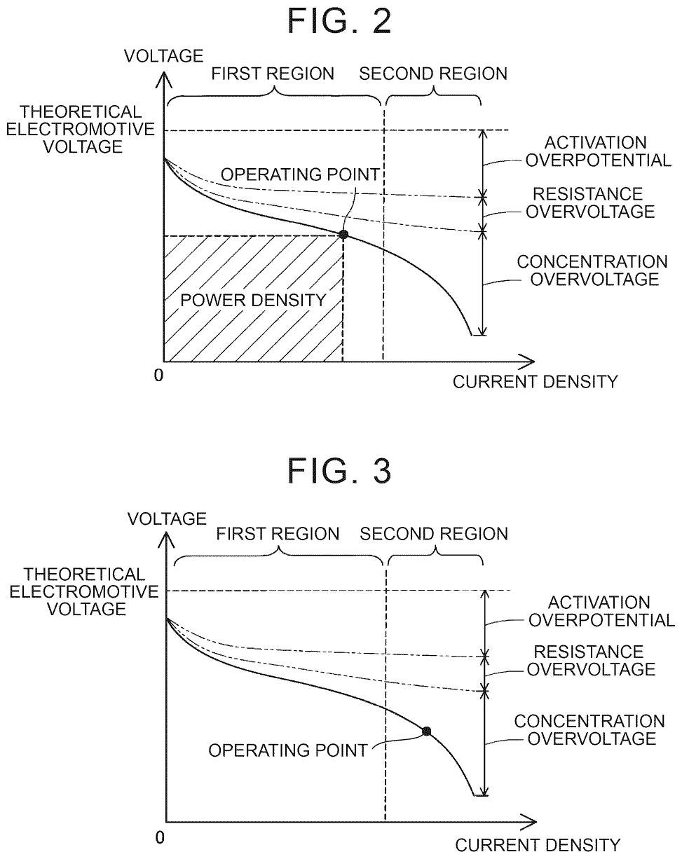

FIG. 2 is an explanatory diagram illustrating an operation point of the fuel cell stack 100. In FIG. 2, the horizontal axis represents the current density of a single cell of the fuel cell stack 100, and the vertical axis represents the voltage of the single cell. The output current If depends on the current density of the single cell. The output voltage Vf depends on the voltage of the single cell. In FIG. 2, the theoretical electromotive voltage is indicated by a broken line. As shown by the solid line in FIG. 2, the voltage of the single cell becomes smaller as the current density of the single cell increases because the overvoltage increases. The overvoltage is divided into an activation overvoltage, a resistance overvoltage, and a concentration overvoltage. As shown in FIG. 2, the larger the current density of the single cell, the larger the ratio of the concentration overvoltage in the overvoltage. Since the output current If depends on the current density of the single cell, the larger the output current If is, the larger the variation of the concentration overvoltage with respect to the output current If is. A region in which the amount of change of the concentration overvoltage in FIG. 2 is small is referred to as a “first region”. A region in which the change amount of the concentration overvoltage in FIG. 2 is large is referred to as a “second region”. The first region is also a region in which the variation of the output voltage Vf with respect to the output current If is large. The second region is also a region in which the variation of the output voltage Vf with respect to the output current If is small. In FIG. 2, a point on a solid line defined by a voltage and a current density of a single cell is an operation point of the single cell. In FIG. 2, the operating point is located in the first region. The power density output by a single cell corresponds to an area on a plane having an operating point as a vertex. The power P1 depends on the power density of the single cell. In this specification, the operation point illustrated in FIG. 2 or FIG. 3 is treated as an operation point of the fuel cell stack 100 in order to facilitate understanding of the technology.

FIG. 3 is an explanatory diagram illustrating an operation point of the fuel cell stack 100. An operation point of the fuel cell stack 100 in a case where the air stoichiometric ratio is lowered and the equal power operation is performed will be described. When the concentration overvoltage due to flooding occurs due to the operation of lowering the air stoichiometry ratio, the operation point is located in the second region as shown in FIG. 3. As described above, an increase in the required current occurs when the output power P1 decreases in response to a decrease in the output voltage Vf due to the concentration overvoltage caused by flooding. Therefore, the control unit 500 increases the flow rate of the cathode gas by the air compressor 230 in accordance with the increase in the required current. As a result, the moisture contained in the fuel cell stack 100 is removed, and thus the concentration overvoltage due to flooding is eliminated. That is, as the output voltage Vf increases, the operating point is located in the first area as shown in FIG. 2. However, an increase in the output voltage Vf causes a difference between the output power P1 and the required power, thereby reducing the required current. In response to the decrease in the required current, the control unit 500 causes the air compressor 230 to decrease the flow rate of the cathode gas. That is, flooding is more likely to occur again. Thus, the operating point varies between the first region and the second region. When the operating point fluctuates, the variation of the output voltage Vf with respect to the output current If changes, and thus it becomes difficult for the control unit 500 to control the output power P1 with a constant accuracy.

Generally, the response speed of the output current If regulated by the output adjustment unit 430, which is a DCDC converter, is faster than the response speed of the flow rate of the cathode gas regulated by the air compressor 230. Therefore, when the variation of the operating point fluctuates, the response of the flow rate of the cathode gas cannot follow the response of the output current If. Therefore, even during an equal power operation, the fuel cell stack 100 may not be able to output an output power P1 that satisfies the required power due to a delay in the response of the flow rate of the cathode gas. That is, the power P1 may be insufficient. The response speed of the output current If is the time from the occurrence of the variation of the required current until the output current If reaches the required current. The response speed of the flow rate of the cathode gas is the time from the occurrence of the variation of the required flow rate until the flow rate of the cathode gas reaches the required flow rate.

### A-5. Method of Controlling Fuel Cell System

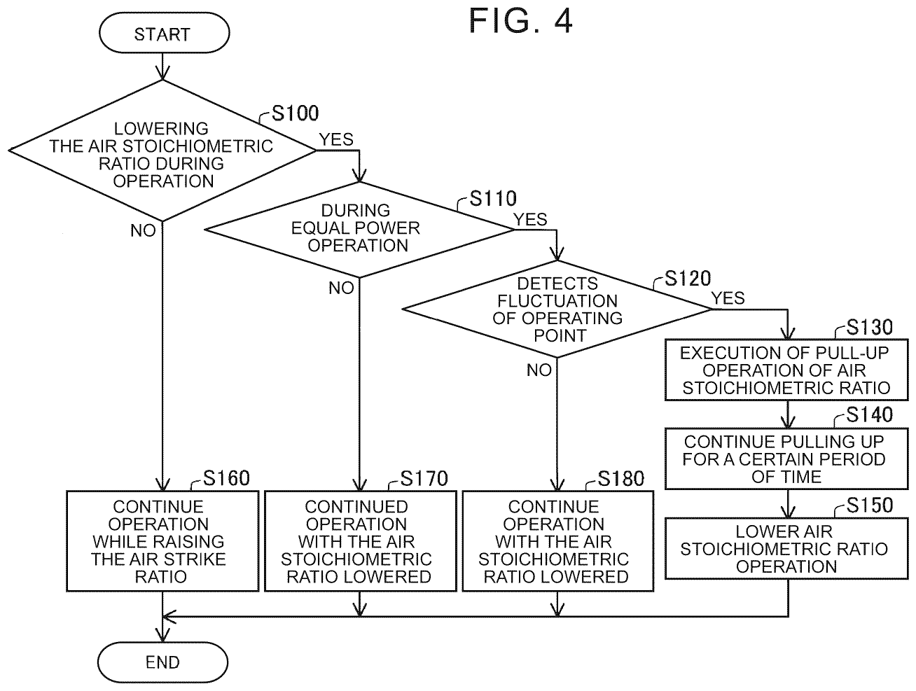

FIG. 4 is a flowchart illustrating a control method of the fuel cell system 10 according to the first embodiment. Hereinafter, a method of controlling the fuel cell system 10 will be described. The control unit 500 repeatedly executes the following processing while the fuel cell system 10 is in operation.

In S100 of FIG. 4, the control unit 500 determines whether the air stoichiometry lowering operation is being executed. That is, when the air stoichiometry ratio is not the second air stoichiometry ratio, the control unit 500 advances the process to S160. When the air stoichiometry ratio is the second air stoichiometry ratio, the control unit 500 advances the process to S110.

In S110 of FIG. 4, the control unit 500 determines whether an equal-power operation is executed. When the equal-power operation is not executed, the control unit 500 advances the process to S170. The control unit 500 advances the process to S120 when the equal-power operation is executed.

In S120 of FIG. 4, the control unit 500 detects a variation in the operating point. In S120, the operation of lowering the air stoichiometry is executed. Specifically, the control unit 500 causes the voltage sensor 410 to advance the process to S130 when the first condition including that the output voltage Vf of the fuel cell stack 100 is within the first range is satisfied. The control unit 500 advances the process to S180 when the voltage sensor 410 satisfies the second condition including that the output voltage Vf of the fuel cell stack 100 is a value included in the second range lower than the first range. Specifically, the output voltage Vf in S120 is the magnitude of the output voltage Vf.

The “second range lower than the first range” means that the upper limit of the second range is lower than the lower limit of the first range. The first range and the second range are defined by predetermined thresholds. More specifically, the threshold value or more is the first range, and the threshold value or less is the second range. The thresholds are set experimentally based on the maximal magnitude of Vf that can be reached, e.g. due to variations in the load power P2.

The first condition further includes that the amplitude of the output voltage in the predetermined period is included in the first range. The predetermined period is set experimentally, in particular based on the response speed of the flow rate of the cathode gas. With such a configuration, the fuel cell system 10 of the present disclosure can suppress the control from being erroneously executed due to the variation of the instantaneous output-voltage Vf shorter than the predetermined period. The instantaneous variation in the output-voltage Vf is caused, for example, by a sudden variation in the load power P2.

In S130 of FIG. 4, the control unit 500 executes an air stoichiometric pulling operation. That is, the control unit 500 increases the flow rate of the cathode gas by the air compressor 230 so that the air stoichiometric ratio becomes the first air stoichiometric ratio.

In S140 of FIG. 4, the control unit 500 continuously executes the pulling operation so that the air stoichiometry ratio is maintained at the first air stoichiometry ratio for a predetermined first time. The first time is the time required to eliminate flooding. In the present specification, the “first time” is also referred to as “drainage time”. The drainage time is set experimentally according to the specifications of the fuel cell stack 100. For example, the drainage time is 30 minutes.

In S150 of FIG. 4, the control unit 500 performs the air stoichiometry lowering operation after the first period of time elapses. That is, the control unit 500 reduces the flow rate of the cathode gas by the air compressor 230 so that the air stoichiometric ratio becomes the second air stoichiometric ratio. With such a configuration, the fuel cell system 10 of the present disclosure can suppress the fuel cell from drying after the lapse of the first time, as compared with a configuration in which the pull-down operation is not performed.

In S160 of FIG. 4, the control unit 500 continues the operation with the air stoichiometry increased.

In S170 of FIG. 4, the control unit 500 continues the operation with the air stoichiometry lowered. S180 of FIG. 4 is also the same process.

The above process is repeated while the fuel cell stack 100 outputs the output power P1. That is, after any of the processes in S150 to S180 of FIG. 4, the control unit 500 starts the process of S100.

As described above, in such a configuration, when the air stoichiometry ratio becomes the second air stoichiometry ratio, the flow rate of the cathode gas decreases as compared with the case where the air stoichiometry ratio is the first air stoichiometry ratio. As a result, the amount of water removed from the fuel cell is reduced, and thus drying of the fuel cell is suppressed. However, in the case where the air stoichiometry ratio is the second air stoichiometry ratio, the amount of water contained in the fuel cell is increased, and thus the possibility that a concentration overvoltage due to flooding occurs is increased. The concentration overvoltage lowers the output voltage Vf of the fuel cell.

The fuel cell system 10 of the present disclosure controls the air compressor 230 so that the flow rate of the cathode gas becomes a required flow rate for outputting an output voltage Vf corresponding to the required current. When the output voltage Vf decreases due to the concentration overvoltage, the air compressor 230 increases the flow rate of the cathode gas. As a result, the amount of water removed from the fuel cell increases, and thus the concentration overvoltage due to flooding decreases. As the density overvoltage decreases, the output voltage Vf increases. In such a case, the air compressor 230 reduces the flow rate of the cathode gas. That is, flooding occurs and disappears again. The occurrence and disappearance of flooding alters the rate of concentration overvoltage in the overvoltage. Therefore, the operating point defined by the output voltage Vf and the output current If of the fuel cell varies.

The fuel cell system 10 of the present disclosure performs the pulling operation for the first time period when detecting the fluctuation of the operating point. As a result, the amount of water contained in the fuel cell is reduced, and thus the concentration overvoltage due to flooding is eliminated. In the pulling-up operation, the air stoichiometry ratio is higher than in the pulling-down operation, so that the amount of water removed from the fuel cell is larger than in the pulling-down operation. That is, in the pulling-up operation, the concentration overvoltage due to flooding is less likely to occur than in the pulling-down operation. Therefore, the fuel cell system 10 of the present disclosure can suppress fluctuations in the operating point. Further, in the fuel cell system 10 of the present disclosure, since the cathode gas is increased in response to the concentration overvoltage caused by flooding, deterioration due to drying of the fuel cell can be suppressed as compared with a configuration in which the flow rate of the cathode gas is increased so as to suppress flooding.

Further, by setting the first condition described above, the fuel cell system 10 according to the present disclosure can suppress the control when the first condition is satisfied from being erroneously executed due to the variation of the instantaneous output voltage Vf shorter than the predetermined period. In the second embodiment, the same effect can be obtained.

In addition, by executing the lowering operation after the first time elapses, the fuel cell system 10 of the present disclosure can suppress the fuel cell from drying after the first time elapses, as compared to a mode in which the lowering operation is not executed.

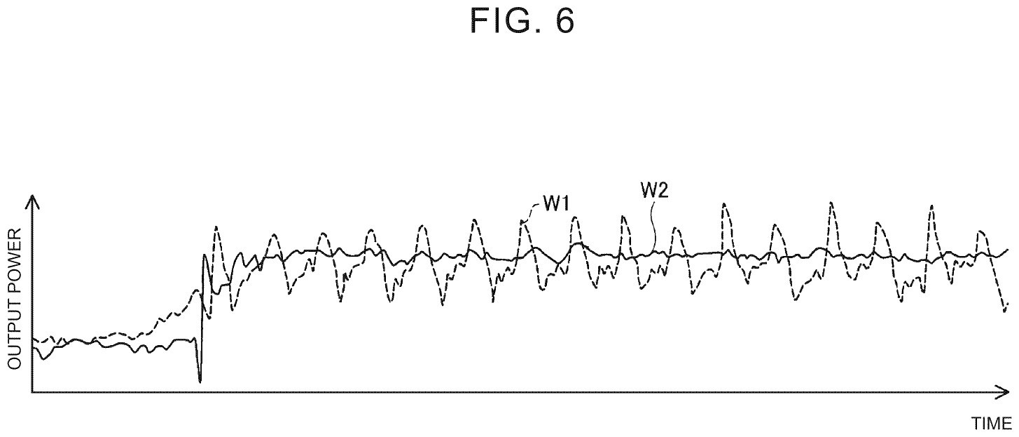

Further, the fuel cell system 10 of the present disclosure can suppress insufficient power P1 by suppressing variations in the operating point. Specifically, the same advantages as those of the second waveform W2 in FIG. 6 of the second embodiment can be obtained.

### B. Second Embodiment

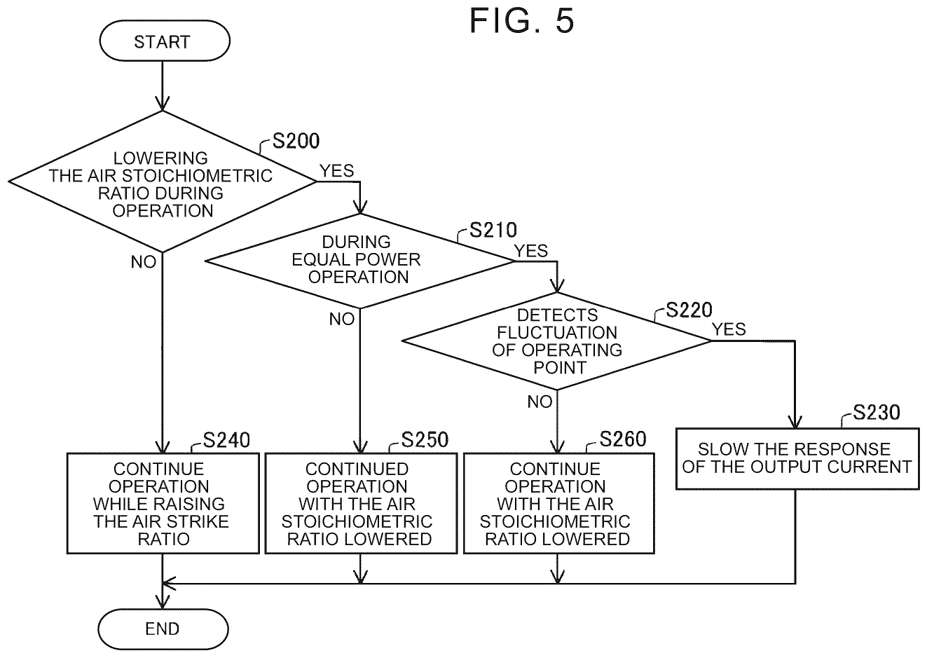

FIG. 5 is a flowchart illustrating a control method of the fuel cell system 10 according to the second embodiment. The fuel cell system 10 according to the first embodiment performs an operation of raising an air stoichiometric ratio in a case where a variation in an operating point is detected. This suppresses fluctuations in the operating point. However, variations in the operating point may be suppressed by other methods. Hereinafter, a method of controlling the fuel cell system 10 according to the second embodiment will be described. The configuration of the fuel cell system 10 of the first embodiment and the configuration of the fuel cell system 10 of the second embodiment are the same. In the second embodiment, the control unit 500 repeatedly executes the following processing while the fuel cell system 10 is in operation.

The processes of $200 to S220 of FIG. 5 is similar to the processes of S100 to S120 of FIG. 4.

In S230 of FIG. 5, the control unit 500 slows down the response rate of the output current If. More specifically, the control unit 500 controls the required current so that the response speed of the output current If becomes a second response speed slower than the first response speed. This control is called “first control”. In S220, the control unit 500 performs the pull-down operation and controls the required current so that the response speed of the output current If becomes the first response speed.

The first response speed is the response speed of the output current If when the first control is not performed during the constant-power operation. The second response speed is the response speed of the flow rate of the cathode gas during equal power operation. That is, the control unit 500 controls the output adjustment unit 430 so that the response speed of the output current If substantially matches the response speed of the flow rate of the cathode gas.

In S230 of FIG. 5, the control unit 500 ends the process after executing the first control.

The process of S240 of FIG. 5 is similar to the process of S160 of FIGS. 4.

S250 and S260 process of FIG. 5 is similar to S170 and S180 of FIG. 4.

The above process is repeated while the fuel cell stack 100 outputs the output power P1. That is, after any of the processes in S230 to S260 of FIG. 5, the control unit 500 starts the process of S200.

As described above, in such a configuration, as in the first embodiment, variations in the operating point defined by the output voltage Vf and the output current If of the fuel cell occur. When the output voltage Vf is included in the first range, the fuel cell system 10 of the second embodiment controls the required current so that the response speed of the output current If becomes a second response speed slower than the first response speed. The air compressor 230 is controlled to have a required flow rate for outputting an output voltage Vf corresponding to the required current. That is, when the required current gradually changes, the flow rate of the cathode gas also gradually changes. As a result, the fluctuation of the amount of water contained in the fuel cell is suppressed, so that the ratio of the concentration overvoltage at the overvoltage is hardly changed. Therefore, the fuel cell system 10 according to the second embodiment suppresses the fluctuation of the concentration overvoltage due to flooding, thereby suppressing the fluctuation of the operating point in the pulling-down operation. Further, the fuel cell system 10 of the second embodiment increases the cathode gas in response to the concentration overvoltage caused by flooding. Therefore, deterioration due to drying of the fuel cell can be suppressed as compared with a configuration in which the flow rate of the cathode gas is increased so as to suppress flooding.

FIG. 6 is a waveform illustrating an output-power P1 according to the second embodiment. In FIG. 6, the horizontal axis indicates the elapse of time, and the vertical axis indicates the magnitude of the output-power P1. The first waveform W1 is a waveform of the output power Pl when the first control is not performed. The second waveform W2 is a waveform of the output power P1 when the first control is performed. As described in the first embodiment, when the operating point fluctuates, the output-power P1 fluctuates due to a delay in the response of the flow rate of the cathode gas. That is, a shortage of the output-power P1 occurs. However, the fuel cell system 10 according to the second embodiment can suppress insufficient power P1 by suppressing variations in the operating point.

### C. Modified Example

(1) In the above embodiment, the first air stoichiometry ratio is 1.5. However, the first air stoichiometry ratio may be 1.5 or more. Further, in the above embodiment, the second air stoichiometry ratio is a value included in the range of 1.2 or more and 1.3 or less. However, the second air stoichiometry ratio may be 1.0 or more and less than 1.5.
(2) In the above-described embodiment, the first condition is a condition including that an amplitude of the output voltage Vf or the output current If in a predetermined period is included in the first range. However, such conditions may not include the first condition. Further, in the above embodiment, the predetermined period is experimentally set based on the response speed of the flow rate of the cathode gas. However, the predetermined period may be set experimentally regardless of the response rate of the flow rate of the cathode gas. Such a configuration facilitates control and setting of the fuel cell system 10 of the present disclosure.
(3) In the above-described embodiment, the control unit 500 executes the pull-down operation after the elapse of the first time. However, the control unit 500 may not execute the pull-down operation after the lapse of the first time. Even when the pull-down operation is not performed, the dry state of the fuel cell stack 100 is reduced because the pull-down operation is already performed.
(4) In the above-described embodiment, the control unit 500 may be configured by a plurality of microcomputers. More specifically, the function of the control unit 500 that executes the raising operation or the lowering operation of the air stoichiometric ratio or the control of the output adjustment unit 430 may not be realized by one microcomputer.
(5) In the above-described embodiment, the control unit 500 detects a variation in the operating point based on the output voltage Vf. However, the control unit 500 may detect a variation in the operating point based on the output current If. More specifically, the control unit 500 advances the process to S130 of FIG. 4 or S230 of FIG. 5 when the current sensor 420 satisfies the first condition including that the output current If of the fuel cell stack 100 is within the first range. The control unit 500 advances the process to S180 of FIG. 4 or S260 of FIG. 5 when the current sensor 420 satisfies the second condition including that the output voltage Vf of the fuel cell stack 100 is included in the second range smaller than the first range. The first range and the second range are set in the same manner as in the case of the output voltage Vf.

What is claimed is:

1. A fuel cell system comprising:
a fuel cell;
an air compressor that adjusts a flow rate of a cathode gas that flows into the fuel cell;
a flow rate sensor that acquires the flow rate;
a current sensor that acquires an output current of the fuel cell;
a voltage sensor that acquires an output voltage of the fuel cell;
a load device that consumes output power of the fuel cell; and
a control unit that controls the fuel cell system, wherein the control unit is configured to:
control the air compressor such that the flow rate is brought to a predetermined required flow rate for outputting the output voltage corresponding to a required current determined based on required power required from the load device and the output power;
execute one of pull-up operation for supplying the cathode gas to the air compressor so as to achieve a first stoichiometric air ratio that is a stoichiometric air ratio of 1 or more, and pull-down operation for supplying the cathode gas to the air compressor so as to achieve a second stoichiometric air ratio that is a stoichiometric air ratio of 1 or more and less than the first stoichiometric air ratio; and
when the pull-down operation is being executed,
execute the pull-up operation for a predetermined first period of time when a first condition is met, the first condition including the output voltage or the output current having a value included in a first range, and
not execute the pull-up operation when a second condition is met, the second condition including the output voltage or the output current having a value included in a second range that is lower than the first range.

2. A fuel cell system comprising:
a fuel cell;
an air compressor that adjusts a flow rate of a cathode gas that flows into the fuel cell;
a flow rate sensor that acquires the flow rate;
a current sensor that acquires an output current of the fuel cell;
a voltage sensor that acquires an output voltage of the fuel cell;
a load device that consumes output power of the fuel cell;
an output adjustment unit that adjusts the output current to a required current determined based on required power required from the load device and the output power; and
a control unit that controls the fuel cell system, wherein the control unit is configured to:
control the air compressor such that the flow rate is brought to a predetermined required flow rate for outputting the output voltage corresponding to the required current;
execute one of pull-up operation for supplying the cathode gas to the air compressor so as to achieve a first stoichiometric air ratio that is a stoichiometric air ratio of 1 or more, and pull-down operation for supplying the cathode gas to the air compressor so as to achieve a second stoichiometric air ratio that is a stoichiometric air ratio of 1 or more and less than the first stoichiometric air ratio; and
when the pull-down operation is being executed and the required current is controlled such that a response speed of the output current is brought to a first response speed,
execute first control for controlling the response speed of the output current to a second response speed that is lower than the first response speed when a first condition is met, the first condition including the output voltage or the output current having a value included in a first range, and
not execute the first control when a second condition is met, the second condition including the output voltage or the output current having a value included in a second range that is lower than the first range.

3. The fuel cell system according to claim 1, wherein the first condition includes an amplitude of the output voltage or the output current in a predetermined period being included in the first range.

4. The fuel cell system according to claim 1, wherein the control unit executes the pull-down operation after a lapse of the first period of time.

5. The fuel cell system according to claim 2, wherein the first condition includes an amplitude of the output voltage or the output current in a predetermined period being included in the first range.
